(19) United States
(12) Patent Application Publication
(10) Pub. No.: US 2004/0024682 A1
(43) Pub. Date: Feb. 5, 2004

(54) Method and system for providing paid notification of item availabilty in an online marketplace

(76) Inventor: Steven Gregory Popovitch, Ann Arbor, MI (US)

Correspondence Address: STEVEN POPOVITCH, 704 N. CHIPMAN, OWOSSO, MI, 48867, US

(21) Appl. No.: 10/209,627

(22) Filed: Jul. 31, 2002

(51) Int. Cl. G06F 17/60

(52) U.S. Cl. 705/37

(57) ABSTRACT

A notification method and system is disclosed which can be implemented in the context of an online marketplace, to the advantage of both the users of the online marketplace and the operator of the online marketplace. This invention enables users to submit requests for receiving priority notifications when an item matching a query becomes available, in exchange for a notification fee payable only if the item is purchased within a predetermined time period after the notification is sent. In a preferred embodiment, the notification fee is variable and determined by the user, in effect creating a novel auction marketplace where users bid for the timely dispatching of notifications.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The disclosed invention relates generally to electronic commerce, and in particular to a method for conducting online sales of items available for immediate purchase. Still more particularly, the present invention provides a method and system for allowing potential buyers to bid for an early notification of the availability of items available for immediate purchase.

### BACKGROUND OF THE INVENTION

Online marketplaces are online services where items can be bought and/or sold. There are several types of online marketplaces, including: online auctions; online fixed-price listing services; and online stores. Online marketplaces share common attributes. They are usually powered by multi-user computer systems running database software, which are used to publish a web site on the Internet. Through the use of a web browser, a multitude of users can browse this web site, view items available for sale, and purchase those items.

In most online marketplaces, items available for sale are classified by categories. This classification of items into categories makes it easier for buyers to browse the items currently available, as they can focus on the categories relating to their interest. Yet, in the most successful online marketplaces, millions of items may be offered at any given time, and a category may contain thousands of items. In order to help prospective buyers to locate items they might be interested in, online marketplaces typically include a search feature. This feature allows users to perform text searches (possibly including wildcards and Boolean expressions) on the current listings titles, descriptions and attributes such as price, or search for a precise product identifier such as an UPC code or a manufacturer's reference number. These searches are also called queries, and the term “query” will further be used to describe the input that can be submitted by a user to select a particular item or group of items.

An online store is a type of online marketplace where the company running the online store is the seller of the advertised items. The company running the online store is responsible for: listing new items; receiving payments from visitors who complete a purchase; and delivering purchased items to those visitors. At any one time, each item can be purchased for a predetermined price. Examples of online stores are: the online store operated by Barnesandnoble.com LLC; the online store operated by Buy.com, Inc.

A fixed-price listing service is a type of online marketplace where the company running the web site is not the seller of the items available on the online marketplace, but allows web site users to list items for sale. In some cases, the company may process the payments when visitors purchase items, but the seller is normally responsible for shipping the purchased items. At any one time, each item can be purchased for a predetermined price. Examples of fixed-price listing service are: the service provided by Half.com, Inc.; the used marketplace of Amazon.com, Inc.

An online auction site is a type of online marketplace where the price of items may change during a predefined bidding protocol. It is possible to make a distinction between two main types of online auction sites: The Consumer-To-Consumer (C2C) where web site users are responsible for listing and shipping items, an example of which is the online auction site operated by eBay Inc.; and the Business-To-Consumer (B2C) where the company running the online auction site (or its partners) is the seller of the advertised items, an example of which is the online auction site operated by uBid Inc.

An online shop aggregator is a type of online marketplace where a company provides a facility allowing a multitude of individuals or organizations to create their own online shops, usually in exchange for a monthly fee and/or a percentage of the sales. Examples of online shop aggregator are: the zShops from Amazon.com, Inc.; the Yahoo! Inc. shops.

While the present invention can be applied with great advantage to all these types of online marketplaces, the workings of online auction sites will now be considered in more detail, as they are excellent targets for the application of this invention. Let's start by describing the traditional auction process: An auction is a sales process in which prospective buyers are permitted to bid on an item offered for sale, according to a predetermined bidding protocol.

In traditional auctions, the item is presented with a minimum (or starting) price and users keep bidding higher amounts until no buyer wishes to bid more than the current high bid. The highest bidder wins the auction and purchases the item for an amount equal to his high bid. This type of auction is usually called an “ascending price” auction.

In another type of auction, the item is presented with a maximum price, which is reduced at regular intervals until a user agrees to buy the item for the current price. In this case, the first user to bid wins the auction. This type of auction is usually called a “descending price” auction.

Until recently, auctions were presented to a group of buyers in a given location by an auctioneer, who conducted the bidding process. But in the last few years, online auctions, in which auctions are conducted in a distributed fashion over the Internet, have emerged. These online auctions remove geographic constraints, and allow any user of an internet-connected computer to view descriptions and pictures of items offered for sale, as well as bid on items using their computer systems. Two patents relating to online descending price auctions have been issued to Godin and Lymburner: U.S. Pat. Nos. 6,266,652 and 5,890,138.

Many online auction sites, such as the eBay Inc. or Yahoo! auction sites, operate as ascending price auctions. A web site is provided through which: a) sellers list an item available for auction for a given time period, with a minimum price and b) buyers bid increasing amounts for this item. When the time period ends, the buyer who has submitted the highest bid wins the auction.

Operators of online auction sites derive revenue from the online auctions in a variety of ways. For example, an online auction site may charge sellers fees including one or more of the following: a fee to list each item; a sales fee substantially computed as a percentage of the sale price; various fees for various options improving the visibility or length of the auction. All these fees are usually charged to the seller. Alternatively, the operator of an online auction site may sell advertising to be displayed on the web site.

Many Internet auction sites feature an “immediate purchase” option, which eBay Inc. calls “Buy It Now” and Yahoo! Inc. calls “Buy Now”. This option allows the seller, at the time he is listing an item, to specify a price at which he is willing to sell this item without waiting for the auction to end. When the item's listing appears on the web site of the online auction, the “immediate purchase” price is displayed along with the item description. Any buyer willing to pay the “immediate purchase” price can purchase the item instantly, without waiting for the auction to end.

From the seller's point of view, the “immediate purchase” option can be attractive, as it may cause the sales process to be faster than the normal auction duration. Also, the seller normally sets an “immediate purchase” price which is satisfactory for him, and which may not have been reached through the normal auction process. The drawbacks for the seller are that the online auction site may charge a fee for using this option, and also that the item final auction price may have exceeded the price set for the “immediate purchase” option.

From the online auction site's point of view, the “immediate purchase” option is moderately attractive. Some auctions featuring this option will end faster, reducing the load on the online auction site's computer systems, but this is a small cost savings. The fee charged for this option cannot be high, otherwise sellers would not use it.

From the buyer's point of view, the “immediate purchase” option can be a mixed blessing. If the listing is noticed in time, it may allow the buyer to make an immediate purchase at a satisfactory price, without the fear of being caught in a bidding war against another bidder. However, the drawback of this option for a buyer is that a desirable item may be sold before he had a chance to see the listing. Even if a buyer is willing to pay a significant premium over the “immediate purchase” price, there is no mechanism allowing him to express this willingness. It is not uncommon for users, afraid to miss a desirable item, to feel compelled to check the online auction listings at frequent intervals. The unfortunate consequence is to make the online auction experience less pleasurable

Accordingly, there is clearly a need for online marketplaces to provide notifications when items become available. Many online marketplaces provide notification (or alert) services regarding item availability, such as:

eBay Inc. provides a service called “Favorite searches”, which allows users to store queries, and to request eBay to send a daily email listing items matching each stored query.

Amazon.com Inc. provides two notification services: the service called “Amazon.com Alerts” sends a notification whenever books, CDs, videos, or DVDs of interest are about to be released; the service called “Available to Order Notifications” sends a notification when an out-of-stock item is once again available, or when highly anticipated items, such as new DVDs, are officially released and able to be ordered.

Zones, Inc. provides a service called “Buyer's Alert”, which allows a user to specify a product, a desired purchase price and an expiration date for the alert. When the chosen product comes into inventory and/or reaches the desired price, the service sends an email notification. If neither criterion is reached by the prescribed date, the alert will expire.

These notification services are useful, especially when large quantities of a given item become available at the same time. In this case, even though many users may receive the notifications, many should be able to purchase the newly available item.

However, these notification services are less satisfactory when only one item becomes available at a given time, which is typically the case for online auction sites. With the prior art notification services:

There is no mechanism for the user requesting the notification to express his desire for the item. For example, a user who desperately needs an item and would be willing to pay twice the asking price may not be notified before an user who has only a casual interest in the item.

The prior art notification services typically send the notifications after the item has been made available for purchase to all users. Users receiving notifications may find out that the item has already been purchased by a user browsing the online marketplace listings.

Notifications are sent at more or less random times, sometimes only once per day as in the case of eBay's Inc. favorite searches service. Users cannot rely on such notifications to be timely enough to allow them to purchase the item before a casual browser or another notified user.

These notification services do not generate any direct revenue for the online marketplace (only possibly indirect revenue by increasing sales).

The notification services of Amazon.com, Inc. and Zones, Inc. are designed to work for products, which can be precisely identified by a product code. They do not readily apply to items such as antiques or collectibles which often are not available new and may not have product codes.

### SUMMARY

In the context of an online marketplace, the present invention provides a method and system for allowing a user to request an early notification of the availability of items available to be purchased immediately, in exchange for the payment of a notification fee if the user purchases the item. This method can be applied to: (a) online auction sites, whether they use an ascending price or descending price bidding protocol; and (b) any online marketplace where at least some items can be purchased for a predetermined price.

The present invention solves a number of the problems discussed in the presentation of the background of the invention. In particular, it:

Provides a mechanism for users to express their desire for an item by specifying a bid amount, and prioritizes the sending of notifications according to the bid amount.

Provides a time period, while notifications are sent, during which only notified users can purchase the item.

Does not require a purchase commitment by users in order to receive notifications.

Provides significant additional revenue to the online marketplace.

For online auction sites, provides a stronger incentive for sellers to use the “immediate purchase” option, as well as improved site functionality (and more peace of mind) for the potential buyers.

The present invention is applicable to any type of online marketplace, provided at least some items are available to be purchased for a predetermined price. For example, the invention would be directly applicable to all types of online auction sites, as well as to the online stores, the online fixed-price listing services and the online shop aggregators described above.

The present invention creates a new type of market, which is a market for information about item availability. It empowers potential buyers to place a price on their desire to be notified first when a given item, or an item matching a query, is newly available for sale.

The present invention includes several of the following steps, which can each be implemented in a variety of ways in various embodiments: (a) receiving and storing notification requests submitted by the users of the online marketplace (b) when a new item is offered for sale in the online marketplace, notifying the users who have submitted notification requests matched by this item; (c) during a time period including the sending of notifications, preventing non-notified users from purchasing this item; (d) if the item is purchased during a predetermined time period by a notified user, billing the purchaser a notification fee for the notification received.

In a preferred embodiment, a user is allowed to submit a notification request to the online marketplace, including a query and a bid, the bid being normally specified as a percentage. If a new item is inserted in the online marketplace which matches his query, and this item is available for immediate purchase, the user will be notified of the item's availability using email, instant messaging, paging, fax or some other type of communication. When receiving the notification, the user can either: (a) purchase the item, in which case he will be billed a notification fee (determined in part from the bid amount submitted); or (b) do nothing in which case no notification fee will be due. In effect the user bids for receiving a priority notification of an item's availability, and these notifications are dispatched in the order of decreasing bids, so that the highest bidders will be notified before the lowest bidders.

In the case of Consumer-To-Consumer online auction sites, It may be advantageous to provide an incentive for the seller to use the immediate purchase option. Various possible incentives are presented below.

In some embodiments, notification fees are charged to the purchaser only during a limited period of time. In these embodiments, it may be advantageous to allow immediate purchases only when a notification fee will be charged for the purchase. This would ensure that a notification fee is always charged in the case of immediate purchases. Provided that the notification fee has a minimum value, for example 2.5%, the minimum revenue for the online marketplace for a given immediate purchase sales volume is easily computed (for example, $10,000 of immediate purchase sales would bring a minimum revenue of $250).

With respect to prior art, this invention provides: (a) a significant new source of revenue for online marketplaces, as it creates a new market for information about item availability; (b) a new tool for potential buyers, which allows them to receive a prioritized notification when an item matching a query is newly available for sale, and provides a time period during which only notified users can purchase the item; (c) possibly reduced fees or other incentives for sellers; (d) a better functioning marketplace where the users most interested in a rare item will have a better chance of purchasing it than less interested users.

### DRAWINGS

FIG. 1 is a general diagram of the architecture of an online marketplace, in which the present invention can be implemented

FIG. 2 shows the different phases occurring after an item is offered for sale in the course of the method of the present invention.

FIG. 3 is a general flowchart of the various sequences of steps performed for the implementation of the present invention.

FIG. 4 shows the database model used in the description of a preferred embodiment of the present invention.

FIG. 5 is a flowchart of the process followed by a preferred embodiment when a new item is offered for sale in the online marketplace.

FIG. 6 is a flowchart of the process followed by the notification thread, whose main purpose is to send notifications.

FIG. 7 is a flowchart of the process followed by a preferred embodiment when a user requests to view an item, including the computation of the additional notification fee.

FIG. 8 is a time diagram showing how the notification fees paid by various users evolve as the notification process proceeds, in a preferred embodiment.

FIG. 9 is a time diagram showing how the notification fees paid by various users evolve as the notification process proceeds, in a variation of a preferred embodiment.

### DETAILED DESCRIPTION

The present invention is described in the context of an online marketplace. An online marketplace is a service in which items are offered for sale or auction, and which allows a large number of users to bid on or purchase items currently offered on the online marketplace. In online marketplaces, items are offered for sale or auction by one or many of the following: (a) the operator of the online marketplace; (b) a third party; (c) any user of the online marketplace. Users of online marketplaces typically are scattered across a large geographical area, and communicate with the computer system(s) running the online marketplace by using a personal computer or other computing device. This communication between the online marketplace users and the online marketplace is performed via communication protocols such as TCP/IP, and takes place on a wide area network such as the internet.

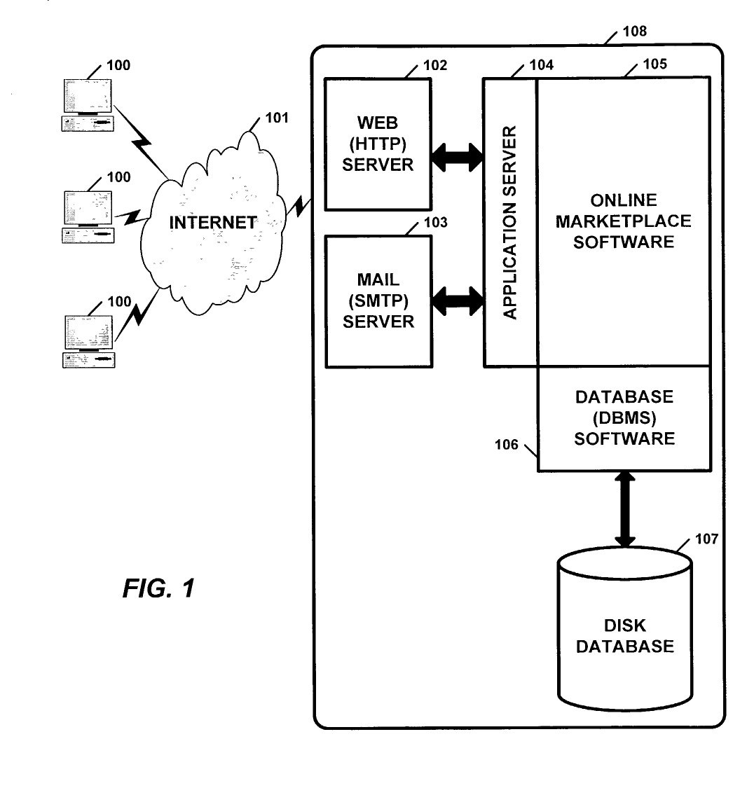

FIG. 1 provides an overview of the online marketplace. A large number of users use client computers 100 connected to an internet network 101 to access an online marketplace web site 108. In practice, online marketplace web site 108 may not be running on a single monolithic computer but rather on a network of interconnected server computers, possibly physically dispersed from each other, each dedicated to its own set of duties and/or to a particular geographical region. Online marketplace web site 108 is powered by a number of software packages, among which most notable are: a web server 102, responsible for the interaction with client computers 100 using a protocol such as HTTP; a mail server 103 responsible for delivering email messages; an application server 104 providing fundamental building blocks for developing web applications; database management software 106 providing services for storing and retrieving data records on disk database 107; and finally online marketplace software 105 implementing the custom methods of the online marketplace.

Items and Notifications

An item, offered for sale in the online marketplace, may be anything which can conceivably be purchased, including objects, properties and services. Examples of items include: collectibles; electronic devices such as consumer electronics and computer devices; automobiles; real estate such as homes, land, commercial and timeshares; photographic equipment; intellectual property such as patent deeds; clothing; event tickets; jewelry; professional services such as translation; musical instruments; etc..

The present invention allows a user of the online marketplace to request a notification when a desired item is offered for sale in the online marketplace. A notification is a message, sent by the online marketplace to the user, intended to communicate the information about the desired item's availability. The notification can be sent as an electronic mail (email) message, in which case it may contain a description of the item newly offered for sale, and possibly a hyperlink (or URL—universal resource locator) which when clicked would display the item's description in a browser window, by connecting to online marketplace web site 108.

Multiple methods are available for sending notifications. Email is the most natural method, as most Internet users have an email address and an email address is usually a requirement for participating in an online marketplace. In a preferred embodiment, email is the default method for sending notifications to users, i.e. the method used unless another notification method is expressly specified.

However, a possible drawback of using email as a method for sending notifications is the lack of immediacy. Other methods for sending notifications may be offered to users, including: (a) instant messaging, such as AOL Instant Messenger by America Online, Inc or Yahoo! Messenger by Yahoo!, Inc; (b) text message or other notification services provided by cellular phone operators or other wireless communication providers; (c) notification via telephone message; (d) paging services; (e) fax; (f) a combination of the above methods, including email.

Some methods for sending notifications, such as telephone, fax, or paging, may require an expense for the online marketplace, and accordingly an additional fee may be billed to the user.

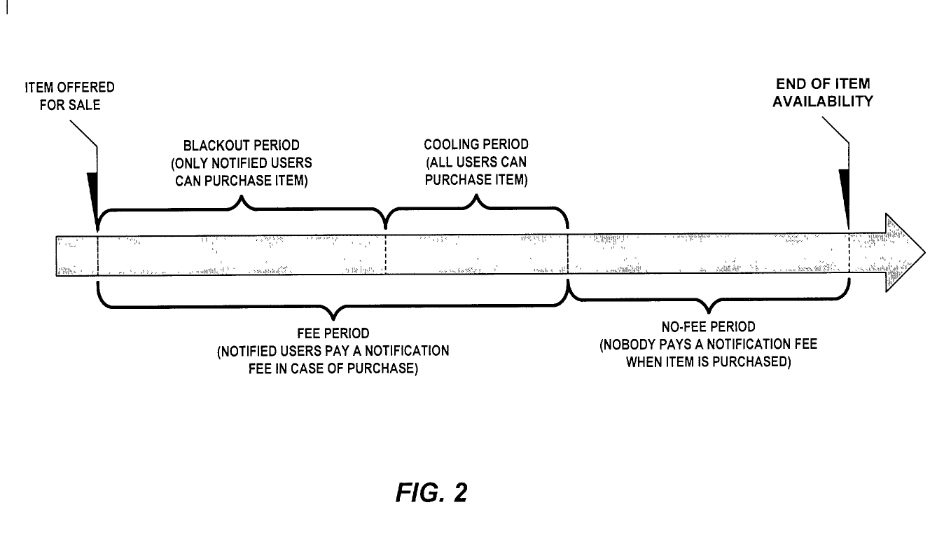

FIG. 2—Time Periods After an Item is Offered for Sale

FIG. 2 shows the different periods occurring in the course of the method of the present invention after an item is offered for sale. The different periods are:

a blackout period, during which only notified users are allowed to purchase the item. If the blackout period is present, the notifications of the item's availability are sent within this period.

a cooling period, coming after the blackout period, during which all users of the online marketplace can purchase the item, but a notification fee is charged (in case of purchase) to those users who have received notifications.

a fee period, during which notified users pay the notification fee if they purchase the item. The fee period includes the blackout period and the cooling period. The fee period is normally present. The fee period may extend in some embodiments up till the end of the item availability, in which case the notification fee is always charged to a notified user who purchases the item.

a no-fee period, during which all users of the online marketplace can purchase the item and nobody is charged the notification fee in case of purchase. In some embodiments, the no-fee period may not be present, in which case the notification fee is always charged to a notified user who purchases the item.

In some embodiments, the blackout period may not be present, in which case the fee period is equal to the cooling period. In some embodiments, the cooling period may not be present, in which case the fee period is equal to the blackout period. For example, there is no need for a cooling period if the immediate purchase option is deactivated at the end of the blackout period, as may happen in some embodiments.

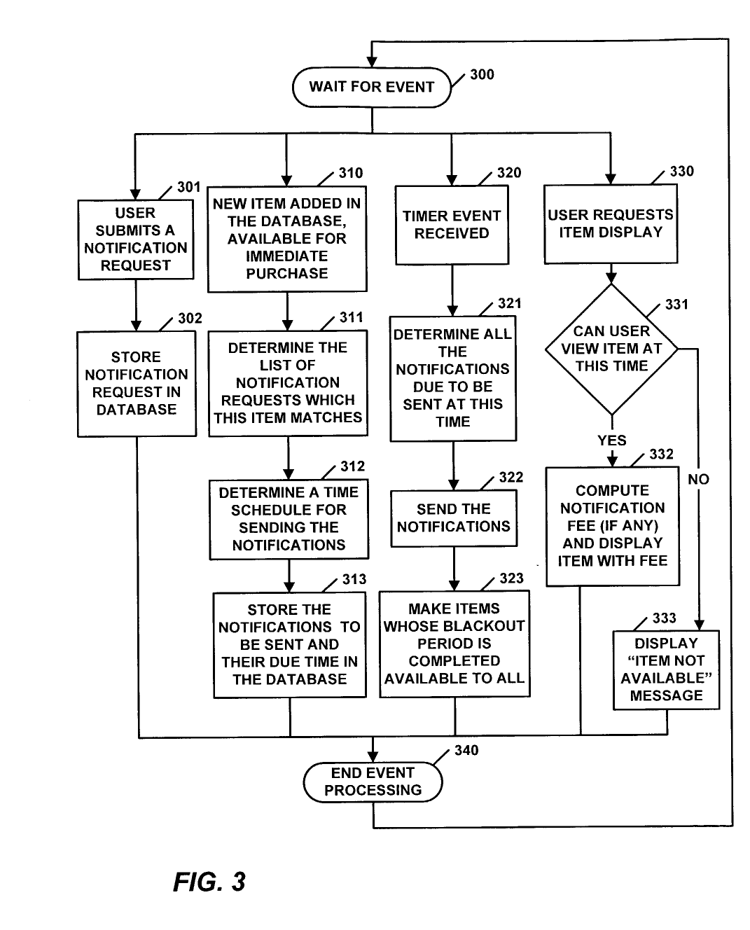

FIG. 3—General Flowchart of the Present Invention

FIG. 3 is a general flowchart of the various sequences of steps performed for the implementation of the present invention. Before those steps are described, some important remarks should be made. First, this flowchart is presented as if all processing is performed by a single thread of execution, which may not be the case. However the steps to be performed will remain the same, even if the response to different events is performed by a number of different threads. Secondly, this flowchart assumes that the online marketplace software is event driven, where one or more threads are waiting for events coming from users or scheduled by the online marketplace software itself. This may not be the case, and the present invention would function equally well when adapted to non event-driven online marketplace software architectures. Third, only the steps relevant to the present invention are described. We do not claim to describe all the steps for implementing an online marketplace. Finally, some processing steps not required for the understanding of the present invention may not be described here.

The flowchart of FIG. 3 displays a main loop, whose main purpose is to process events coming either from users of the online marketplace, or scheduled by the online marketplace software itself. The loop is organized with wait step 300, the processing of the event received, and the end of event processing 340 after which it loops back to wait step 300.

In step 301 of FIG. 3, the online marketplace software receives a notification request submitted by a user. The notification request is a way of specifying a query (or filter) though which only the items that the user is interested in will pass. By submitting the notification request, the user is asking the online marketplace to notify him whenever a new item matching the specified query is added in the online marketplace.

The notification request includes at least a query, which is a specification that an item must match to be included in the query result. A query can be very simple, such as a product code (for example a Manufacturer's reference code or UPC code if available), in which case only items with exactly this product code will be said to match this query. This type of query works well if the online marketplace sells items easily identifiable by a code, such as books easily identified by their ISBN. In other online marketplace cases, the items available for sale are unique and may not have a product code, and the seller provides a description which may include a title, a textual description, photos, a warranty, shipping costs, etc. In this case the query normally includes one or more query string(s), which may include: words; wildcards; regular expressions; Boolean operators such as “and”, “or” and “not”; quotation marks to search for exact phrases; grouping operators such as parentheses; special operators to match a given number of words out of a group.

The item attributes that the query string(s) will be applied to may also be specified in the query: for example: one query string may be supplied, to be applied only to the item's title; or one query string may be supplied, to be applied to both the item's title and the item's description; or two query strings may be supplied, one to be applied to the item's title and one to be applied to the item's description.

The query strings may be supplemented by additional restricting conditions such as: the location; the price range; the list of categories that the item must belong to; the type of payment accepted; the identity of the seller; and other restrictions. So a query is defined as a search specification, which may include one or more of the following,: (a) a product code; (b) one or more query strings, along with the item attribute(s) these query strings should be applied to; (c) additional restricting conditions.

The notification request may also include a bid, normally specified as a percentage, which is an additional percentage of the item price that the user is ready to pay in order to receive a priority notification when an item becomes available. For example, a collector of spy cameras may lack a rare “Minox Riga”, and may be willing to offer 20% extra in order to increase his chances to be notified first when one such camera becomes available. He could then submit a notification request with a bid of 20% and a query including: (a) a query string, applicable to the item's title, such as: “minox riga -replica”, where the -replica prevents titles containing ‘replica’ from matching; (b) a price restriction to only select items offered with an immediate purchase price greater than $300. In this example, if a camera matching his query is offered with an immediate purchase price of $500, and no other user submitted a notification request with a greater bid, the collector would be among the first users to be notified and have a chance to purchase the camera instantly for $600 ($500 plus a $100 notification fee corresponding to his 20% bid). He may also decide not to purchase the camera, in which case he will not be billed a notification fee.

The reason why the collector may not be guaranteed to be the very first user to be notified is that notifications may be grouped together, so a minimum time is maintained between groups of notifications. In this case, by submitting the highest bid, the collector would only be guaranteed to be in the first notification group. When notifications are grouped, the method could also ensure that all the users notified at the same time (i.e. belonging to the same notification group) will be billed the same notification fee in case of purchase.

It may also happen that the asking price of the item, with the addition of the notification fee, proves too high for the user. In the previous example, the collector may feel that his 20% bid locks him out of the purchase of this camera, for which he is ready to pay $550 at most. To allow people submitting high bids to remain candidates for purchasing items, a decrease of the notification fee during the fee period may be desirable, and is provided in some embodiments of the present invention. This would allow the collector, if not willing to purchase the camera immediately for $600, to wait for the decrease of the notification fee to $50 or lower before purchasing the camera. Of course, the risk is that someone else will purchase it before him!

It might be desirable to set a minimum value for the bids submitted in notification requests, for example 2.5%. This may help prevent users from overloading the system by requesting many notifications with very low bids, and would also provide for a minimum notification fee during the cooling period. Another option may be to allow only bids having non-zero integral values, in which case the minimum bid would be 1%.

It might also be desirable to set a maximum value for the bids submitted in notification requests, for example 100%. As the bids will be used for prioritizing the delivery of notifications, and depending on the method used for determining the time schedule of notifications, a restricted range of bid values may prove advantageous.

Also the method by which a user can submit the notification request in step 301 may vary. For example, a specific web form may be presented specially for this purpose, allowing the user to specify the query (including the query string(s), the item attributes to be queried, and the restricting conditions), Alternatively, the online marketplace software may allow any search performed against the current listings to be saved as a notification request, and to be used as a notification tool when further items matching the query become available.

Regardless of the method by which the notification request is submitted, the main action taken is to store this notification request in a database, as shown in step 302. An identifier used to uniquely identify the submitting user is also stored along with the notification request.

In step 310 of FIG. 3, a new item is added to the database (i.e. is offered for sale) and is available for immediate purchase, which means that it can be purchased for a predetermined amount of currency. For online auction sites, this means that the seller offering the item indicated a price (the predetermined amount of currency) for which the item can be purchased immediately, without waiting for the end of the normal auction duration.

Depending on the type of online marketplace, the item may be added by a user, or may be added by the operator of the online marketplace, in which case the online marketplace functions like an online store. When an item is added to the online marketplace, all the notification requests are checked against the newly added item and a list of matching notification requests is generated (step 311). In some cases, it may be possible to pre-compile the queries included in the notification requests in order to speed up step 311. Once the list of matching notification requests has been determined, a time schedule for delivering these notification requests is established (step 312). This time schedule may be influenced, as will be described later in the description, by a bid submitted along with the notification request. Based upon the list of matching notification requests and the time schedule, a number of notifications, each including a due time, are generated and stored in the database (step 313)

In one embodiment of the present invention, the item is not made available for public browsing or searching during a blackout period. As a result, only those users who submitted matching notification requests and are notified of this item addition to the online marketplace will be able to purchase this item during the blackout period.

In step 320 of FIG. 3, a timer event occurs. Such events are scheduled by the online marketplace software and may be set to occur at regular intervals, for example every 5 seconds. A regular timer event has been chosen to wake up the process at regular intervals in order to dispatch the notifications, but alternative methods can be used. For example, it would be possible after notifications are added in the database to determine the exact delay between the current time and the time when the next notification is due to be sent, and wait with a timeout set to this computed delay. When the online marketplace software receives the timer event, the list of notifications to be sent is determined by using a SQL database request (step 321), requesting all the notifications whose due time is less or equal to the current time. This SQL request returns all the notifications which are due, and these are sent to the users who requested them (step 322).

In step 323 of FIG. 3, the online marketplace software lists the items, which have completed the blackout period, as visible (and available for purchase) by all users. This step is necessary for embodiments implementing the blackout period, i.e. where items are not made available for public browsing or searching immediately when added to the online marketplace. One method for achieving this step is to generate a ‘special’ notification during step 313 which will mark the time when items should be publicly available.

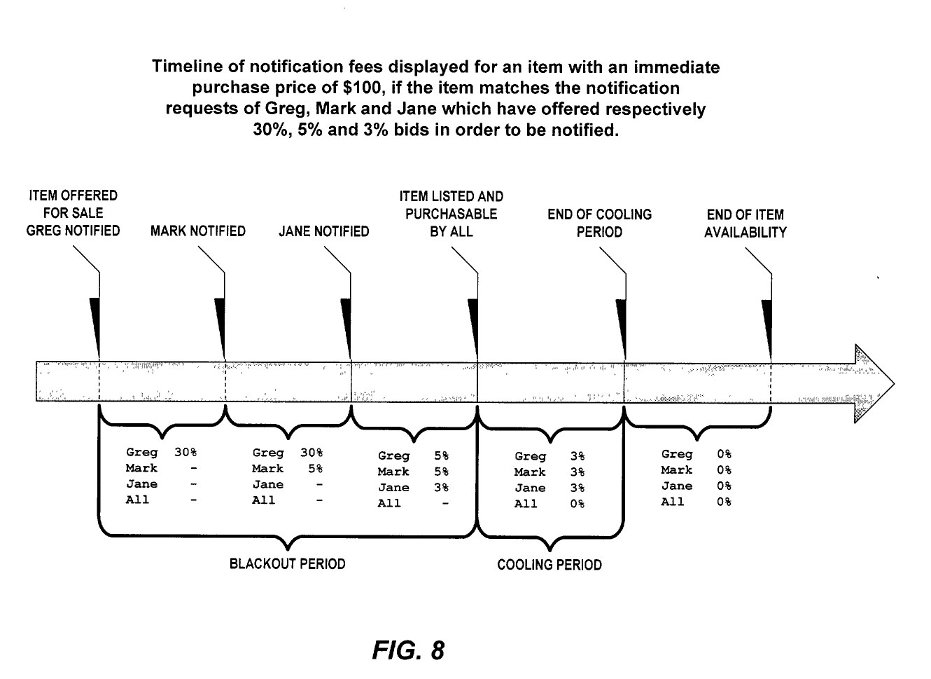

Finally, the last sequence of steps described in FIG. 3 shows the process followed when a user requests to view an item's description, including its price (step 330). During the blackout period, this request will often be caused by the user clicking on a hyperlink (URL) received in his notification message, but it may also come from a request to view a specific item number or another facility of the online marketplace's web site. The next step (step 331) is to determine if the user is eligible to view and purchase the item at the present time, and if the answer is positive we will compute the notification fee billable to the user in case of purchase of the item and display the item description, including the purchase price and the currently applicable notification fee (step 332). The notification fee may be predetermined and constant, or may decrease during the fee period. FIG. 8 shows the timeline of notification fees decreasing during the blackout period in a preferred embodiment of the present invention.

Now we will describe how we prevent non-notified users from purchasing the item during the blackout period. If we determine in step 331 that the user is not eligible to view and purchase the item at the present time, we should display a message stating that the item is not available for purchase now (step 333). If we choose to show a normal item display, including title, description, photos, etc . . . ) along with this message, we should ensure that the buttons or links allowing the purchase of this item are inactivated, or that they display a message stating that the item cannot be purchased now.

There are different methods by which the notification fees can be billed to the user. Normally, users are billed at regular intervals (typically monthly) to cover the fees incurred during the previous period. It is simple to maintain a balance due for each user in the database, along with the transactions causing the various notification fees. Alternatively to periodic billings, notification fees could also be billed as they occur. There are also different methods by which users can pay the notification fees. Normally, when the user registers to participate in the online marketplace, he is required to provide a current credit card or other payment method. This payment method is then stored in the online marketplace database. If such a payment method has been submitted, the online marketplace will typically debit the amount of the notification fees billed using this payment method (typically credit cards). However, some online marketplaces may allow other methods of payment, such as checks or online transfer of funds.

Preferred Embodiment

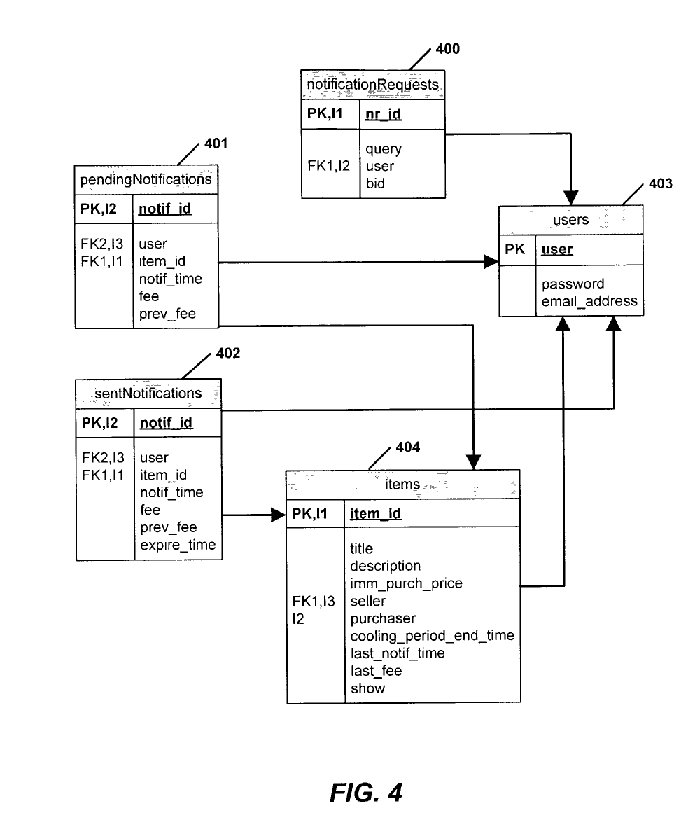

In this part of this description, we will describe in greater detail a preferred embodiment of the present invention, which is detailed in FIGS. 4 to 8.

In a preferred embodiment, a user is allowed to submit a notification request to the online marketplace, including a query and a bid, the bid being normally specified as a percentage. If a new item is offered for sale in the online marketplace which matches the query, and the item is available for immediate purchase, the user will be notified of the item's availability using email, instant messaging, paging, or some other type of electronic communication. When receiving the notification, the user can: (a) purchase the item, in which case a notification fee (determined in part from the amount of the bid submitted) will be billed to him if the purchase occurred during the fee period; or (b) do nothing in which case no notification fee will be billed. In effect the user bids for receiving a priority notification of an item's availability, and these notifications are dispatched in the order of decreasing bids, so that the highest bidders will be notified before the lowest bidders.

When a new item, available for immediate purchase, is offered for sale in the online marketplace, the following steps are followed in sequence: (a) all current notification requests are processed against the newly offered item, and a list of matching notification requests is generated; (b) if the list of matching notification requests is empty, the process ends; (c) the matching notification requests are sorted by the amount of the associated bid offered, highest bid first, and the potential buyers are notified of the item availability in the order of the sort result, with a variable time period between these notifications and after the last notification; (d) the item is listed on the online marketplace and is visible and purchasable by anyone. During the notification step (c), only those potential buyers who have already been notified are eligible to purchase the item. When one of the notified users requests to view the item during the notification step (c), the notification fee to be paid by the buyer is computed and displayed.

In a preferred embodiment, the notification fee payable by a notified user decreases during the blackout period, as the notifications are being sent, and eventually becomes zero after the cooling period. An example of this decrease of notification fees is shown in FIG. 8. This allows users who bid a large percentage, but are unwilling to pay a large notification fee for a given item, to still be candidates for purchasing the item later as their notification fee decreases towards zero.

FIG. 4: Preferred Embodiment: Database Tables

FIG. 4 shows the data fields and the relationships of the database tables maintained by the online marketplace software: user table 403, which contains the list of all users registered to use the online marketplace, and is updated when a new user registers, updates or cancels his registration; items table 404, which contains the list of items available for purchase on the online marketplace, and at least some of the items whose transaction has already been completed; notificationRequests table 400, which contains the active notification requests submitted by the online marketplace users in order to receive priority notifications when items matching their notification request become available for purchase; pendingNotifications table 401, which contains the list of notifications which are to be sent; sentNotifications table 402, which contains the list of notifications which have already been sent. Online marketplaces will maintain other database tables, but describing these other tables is not necessary for the comprehension of this invention. Also, only the fields useful for the comprehension of this invention are included in the tables.

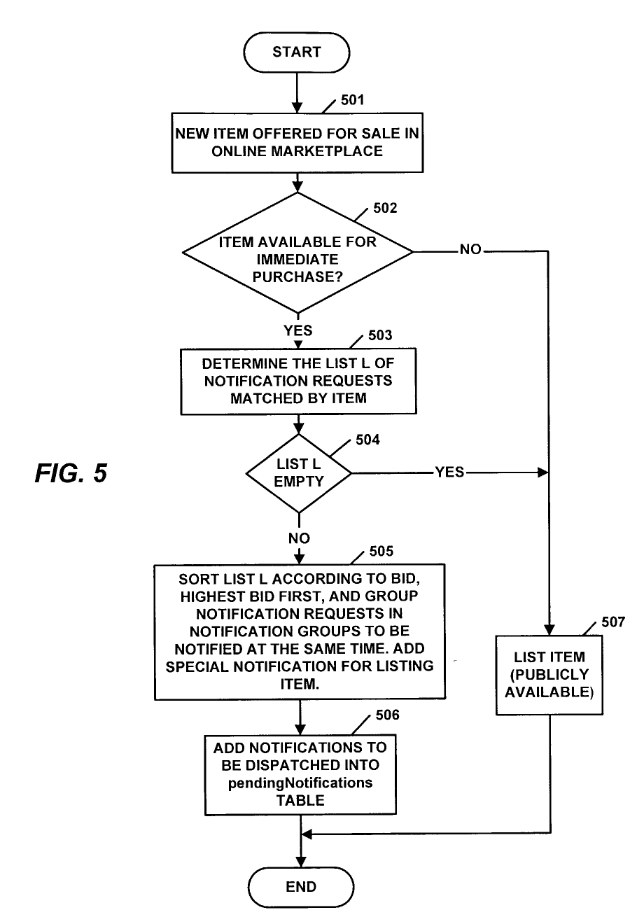

FIG. 5: Preferred Embodiment: New Item Offered for Sale

FIG. 5 is a flowchart describing the steps performed in a main embodiment of the present invention when a new item is offered for sale in the online marketplace. The seller of the item may be: (a) a user of the online marketplace; (b) the operator of the online marketplace; (c) a third party acting in association with the operator of the online marketplace. However, the nature of the seller has no influence on the implementation of the present invention.

In step 501, a new item is offered for sale in the online marketplace. In step 502, we test whether the item is available for immediate purchase. Immediate purchase availability means that a buyer can immediately purchase the item for a predetermined price, without having to wait for the end of a time period. Even in the case of online auction sites, some items may be marked as available for immediate purchase for a price determined by the seller.

If the item is not available for immediate purchase, then the notification phase is skipped, and the item can be listed (step 507) in the relevant categories and made publicly available, i.e. it can be viewed and purchased by any user of the online marketplace.

If the item is available for immediate purchase, then this item will enter a blackout period, which will last for a predetermined length of time, and during which the users who have submitted matching notification requests will be notified of this item's availability. During this blackout period, this item will be purchasable only by users who have been notified. This is a way to prevent a notified user (who would have to pay an additional notification fee) from using a friend as a proxy for purchasing the item, whereby he would avoid paying the notification fee.

The remainder of the processing involves preparing the notifications that will be sent during the blackout period. First, in step 503, we determine the list of notification requests which this item matches. For every notification request, we check whether the included query matches the newly added item, and if the answer is positive we add this notification request to the list of matching notification requests.

In step 504, we check whether the list of matching notification requests is empty, which would mean that no user has submitted a notification request matching the newly added item. If this is the case, we exit the notification phase and proceed to step 507, where we list the item (the item becomes publicly available).

If the list of matching notification requests is non-empty, we will use this list to prepare a time schedule for sending the notifications, which is step 505 of the flowchart in FIG. 5. The first thing we will do in this step is to keep only one notification request for each user. Since a user can submit multiple notification requests, it is possible that the newly inserted item matches more than one notification request submitted by a given user, in this case we will keep the notification request with the highest bid value.

Then we have to decide the time schedule for sending the notifications. The first parameter to establish is the duration of the blackout period, which is the length of time during which notifications are sent and the item is not publicly available. We will use the symbol ‘_blackout’ to represent this duration, and a typical value would be a few hours (we believe that a selection within a range between 4 hours and 24 hours would be best).

Different strategies can be used for establishing this time schedule. We have established that the notifications should be sent ordered according to their bid value, highest bid first. One strategy could be to schedule the delay for each notification in exact proportion to the amount of the bid. Using this strategy, the notification with the highest bid ‘highest’ would be sent at time t=0 of the notification period, while other notifications with a bid ‘_bid’ would be sent at time:

t=((_highest−_bid)/_highest)*_blackout

We have chosen another strategy for determining the notification time schedule in a preferred embodiment, which we will describe now. We prefer to group notifications so that we maintain a minimum time interval (which we call _min_interval) between notification groups. A typical value for _min_interval would be sixty minutes. If there are more than _blackout/_min_interval notifications to be sent, then we need to group some of these notifications together to be sent at the same time. When we group notifications, we ensure that all notifications within a group will be associated with the same notification fee, equal to the lowest bid in the notification group. This seems fair, as users notified at the same time would be charged equal notification fees, but it is not a requirement for this invention. We could for example choose to make notification fees equal to the bid values, in which case notifications could have different notification fees within a group of notifications to be sent at the same time.

The last important part of step 505 is the generation of a ‘special’ notification, which is not used to send a notification, but instead to mark the end of the blackout period and to list the item as publicly available (so it can be browsed, viewed and purchased by any user of the online marketplace). This last notification will be scheduled _min_interval after the last real notification is scheduled to be sent. This ensures that the last user(s) notified will enjoy a full _min_interval time period after its notification has been sent during which the item is not publicly available. The special notification is generated with an associated fee value of zero, which will allow the non-notified users to purchase the item without a fee during the cooling period. The ‘user’ field of the special notification will contain the reserved value ‘show’.

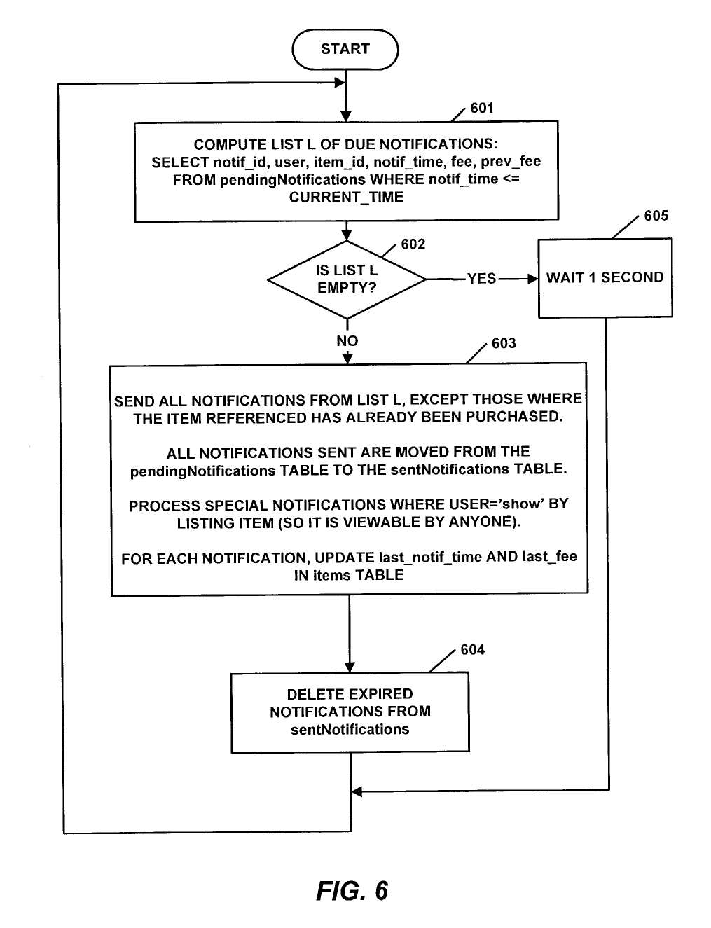

The last step 506 of FIG. 5 is to add the notifications (along with their due time) to the pendingNotifications table. As we will see in the following description of the FIG. 6 flowchart, a separate thread is responsible for searching this table at regular intervals, looking for notifications due to be sent, and processing them.

FIG. 6 and FIG. 8—Preferred Embodiment: Sending Notifications

In FIG. 6, we present the flowchart of a separate thread of execution, whose purpose is to check at regular intervals whether there are any pending notifications which are now due to be sent (or processed in case of the special notification). This processing does not necessarily have to be performed by a separate thread, but this architecture makes the presentation and understanding of the invention easier.

This separate thread can be understood as an infinite loop, which includes a wait period during the loop (step 605). First step 601 is to compute the list of notifications which are due to be sent (or processed in case of the special notification). This list can easily be retrieved by using a SQL request on the pendingNotifications table, asking to retrieve all notifications whose due time is less or equal than the current time. If this list is empty (step 602), this thread has nothing to do at the present time and we can jump to wait step 605 in order to wait a predetermined amount of time before checking again the pendingNotifications table. This wait step is useful in order to reduce the amount of processing time used by this thread, as well as reducing the load on the database management system and permanent storage facility.

If the list of due notifications is non-empty, it contains all the notifications due to be processed. For each notification in this list, we perform the following steps: (a) check in the items table if the item still is present has not already been purchased, otherwise we skip the remaining steps of the notification processing; (b) remove the notification from the pendingNotifications table; (c) if it is a special notification, then make the associated item publicly available, else send the notification to its user; (d) add the notification to the sentNotifications table; (e) update fields last_notif_time and last_fee in the items table to contain the time this notification was due to be sent, as well as the notification fee used in the previous notification group.

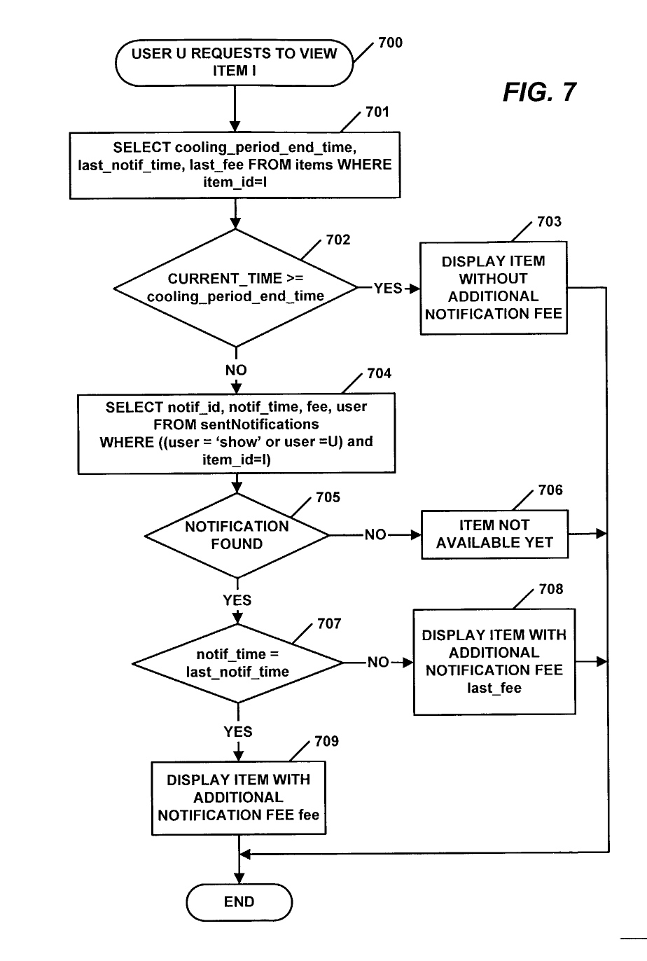

In order to understand the purpose of the fields last_notif_time and last_fee of the items table, let's jump to FIG. 8, which presents an example of the notification fees quoted to various users at different time periods during the fee period. As we can see in FIG. 8, after a user is notified, his notification fee will decrease as other notifications are sent, but with a delay with respect to the later notifications. Without this delay, the user notified first could wait for the notification fee to decrease, and then purchase the item immediately after the notification fee decrease, before the newly notified users have a chance to act upon their notifications. With this technique, the newly notified users enjoy, for a time period, the lowest price available on this item. The fields last_notif_time and last_fee of the items table are used to compute the notification fee quoted to users during the blackout period, as we will see when we describe the FIG. 7 flowchart.

FIG. 8 also shows the cooling period, which is necessary to prevent notified users from purchasing the item immediately after the blackout period, before non-notified users have a chance to see the listing. The cooling period is a time where the item is listed in all the relevant categories, and non-notified users can purchase the item without paying a notification fee. During the cooling period, notified users can also purchase the item, but still have to pay a notification fee.

We have seen how the notification fees of a given user decrease as later notifications are sent to other users. However, this mechanism may not be satisfactory when there are very few (maybe only one or two) matching notification requests, as the notification fees would not decrease smoothly, but in large steps. In this case, it might be desirable to use another technique to smooth out the decrease of the notification fees. For example we could generate another type of special notifications, whose sole purpose would be to cause a decrease of the notification fees for previously notified users, without causing any actual notification to be sent.

Going back to FIG. 6. After processing every notification from the list of due notifications, we remove the expired notifications from the sentNotifications table in step 604. This is easily performed using a SQL statement such as “DELETE FROM sentNotifications WHERE current_time>expire_time” as each notification contains an expiration timestamp expire_time marking the end of the cooling period.

FIG. 7—Preferred Embodiment: Computing the Notification Fee

In FIG. 7, we present the flowchart detailing the steps followed in order to compute the notification fee to be displayed, when a user requests to view an item (step 700). We will use the symbol I to identify the item_id of this item and the symbol U to identify the requesting user. First step 701 is to retrieve information from the items table using the SQL statement: “SELECT cooling_period_end_time, last_notif_time, last_fee FROM items WHERE item_id=I”. If the item has completed the cooling period (test 702), then it is displayed without any additional notification fee (step 703). If the item has not completed the cooling period (test 702), we need to determine the notification fee applicable to user U. This notification fee will be determined by checking whether we sent a notification to user U, and if yes whether this notification was in the last group sent. This is achieved with the SQL statement: “SELECT notif_id, notif_time, fee FROM sentNotifications WHERE ((user=‘show’ or user=U) and item_id=I)” in step 704. If no notification is found (test 705), then user U has not been notified, and we are not in the cooling period or we would have found a special notification where user=‘show’. Therefore user U is not entitled to view or purchase item I at this time, and we display a message with this statement in step 706. If the SQL statement returns two notifications, it means that we are in the cooling period (and we found the special notification) and that user U received a notification (the second one found). In this case we discard the special notification (where user=‘show’) and we proceed as if one notification was returned. If the SQL statement returns one notification, then if this notification was part of the last notification group (test 707), the notification fee to be displayed is the notification fee associated to this notification group (step 709), otherwise it is the notification fee associated to the last notification group (step 708). The case where the special notification (the notification where user=‘show’) is found happens during the cooling period if user U has not been notified, and in this case we display no fee (no special processing is necessary, as a fee value of zero is associated with the special notification).

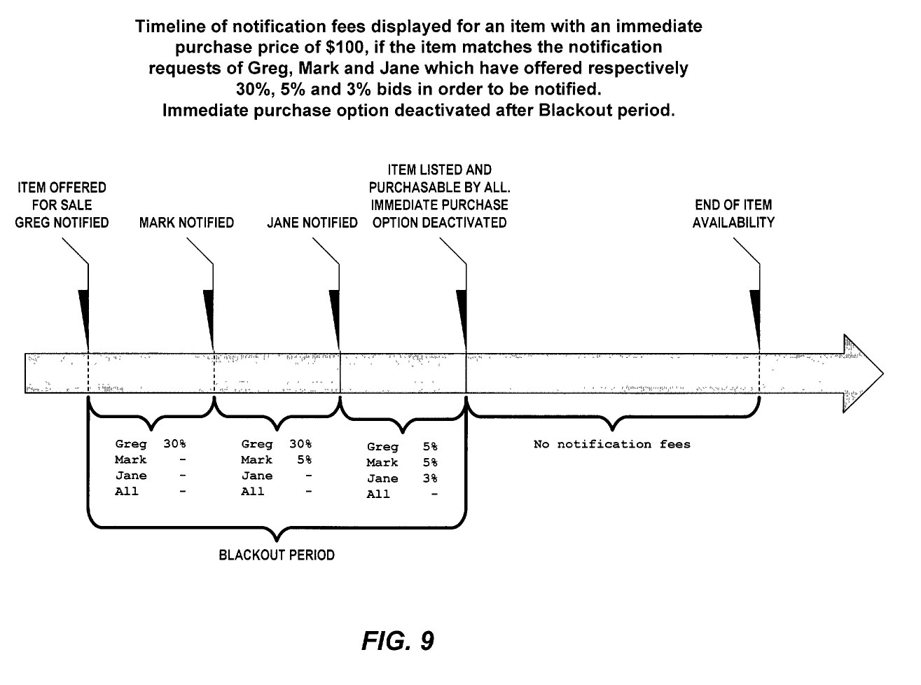

FIG. 9: Deactivating the Immediate Purchase Option

In a variation of a preferred embodiment, and in the case of online auction sites, the operator of the online auction may choose to deactivate the immediate purchase option immediately after the blackout period. This can be done for all auctions, or only at the seller's request (i.e. is the seller selects this option when offering his item for sale)

If the immediate purchase option is deactivated immediately after the blackout period, only notified users will have the opportunity to purchase the item without waiting for the end of the auction. The cooling period becomes unnecessary, as the item sale process will extend to the normal auction duration. This would also ensure that a notification fee is always charged in the case of immediate purchases. Provided that the notification fee has a minimum value, for example 2.5%, the minimum revenue for the online marketplace for a given immediate purchase sales volume can be easily computed (with a 2.5% minimum notification fee, $10,000 of immediate purchase sales would bring a minimum revenue of $250).

Also, during the cooling period, non-notified users can purchase the item without paying a notification fee. This could allow some notified users to avoid paying the notification fee, by using a proxy such as a friend or a duplicate online identity to purchase the item. Deactivating the immediate purchase option immediately after the blackout period would prevent this from happening.

FIG. 9 displays a time diagram showing how the notification fees paid by various users evolve when the immediate purchase option is deactivated immediately after the blackout period. After the blackout period, the item is listed and is visible by all, but the sale protocol for this item then becomes a regular auction.

Incentive to Seller for Using the Immediate Purchase Option

In the case of Consumer-To-Consumer online auction sites, It may be advantageous to provide an incentive for the sellers to use the immediate purchase option. Such incentives may include one or more of the following: reducing or removing altogether the fees for some listing options, such as the immediate purchase option; crediting the seller of an item with part of the notification fees received as a result of this item's sale; entering sellers, using the immediate purchase option, into lotteries or raffles, where the price could be a credit for fees; providing various benefits, such as monthly bonuses or health care, if a seller achieves a high volume of immediate purchase sales.

Displaying Notification Fee Information

As we have seen, notified users will be billed a notification fee when purchasing an item during the fee period. This notification fee should be displayed when the user requests to view the item information. The notification fee may be displayed separately from the item's price, or included in the item's price so only a total price appears. This latter option is relevant especially for online marketplaces which bill purchasers for transactions, and provide invoicing and payment processing.

When displaying the current notification fee to a user, the online marketplace may also inform this user as to when the notification fee will decrease and its next value. This can be done for example by displaying a sentence such as: “Notification fee will decrease to 3% in 27 minutes” or “Notification fee will decrease to $6.33 in 27 minutes”.

Similarly, if the immediate purchase option is to be deactivated after the blackout period, this can be communicated to the user with a sentence such as: “Immediate purchase option expires in 2 hours 27 minutes” or “Immediate purchase option expires on Jul. 21, 2002 12:36:21 PDT”.

Conclusion, Ramifications and Scope of Invention

Thus the reader will see that the method of the invention provides a mechanism for delivering notifications of item availability in an online marketplace which is highly satisfactory for all parties: buyers can price their desire for being notified in priority of an item availability, without any purchase or fee commitment, and receive timely notifications when desired items become available; sellers may enjoy lower fees and items selling faster, and finally the online marketplace operator will significantly increase its profits by charging additional notification fees. While my above description contains many specificities, these should not be construed as limitations on the scope of the invention, but rather as an exemplification of one preferred embodiment thereof. Many other variations are possible. For example:

Different methods can be used for determining the time schedule establishing the time when notifications will be sent, and depending on this time schedule the notification fees incurred by an eventual purchaser can be adjusted in various ways.

The method by which the notification fee is presented and billed may vary. For example, instead of being billed directly to the purchaser, the notification fee could be added to the stated purchase price (transparently for the buyer) and then billed to the seller. This may be more satisfactory for the buyer as he would not be aware that a notification fee is levied upon him.

A portion of the notification fee received could be redistributed, for example to the seller, in order to make the immediate purchase option in online auction marketplaces more attractive.

A simpler notification fee system could be used, where no bid would be required in notification requests. Examples of simpler notification fee systems include: (a) a fixed notification fee (for example 2.5% of the item's price), which would be added if the purchase occurs during the fee period; (b) a linearly decreasing notification fee during the blackout period (for example 10% decreasing linearly to 2% during the blackout period); (c) a notification fee decreasing in steps during the blackout period (for example: 10%; 7.5%; 5%; 2.5%). In these examples all notifications would be sent substantially when the item is added to the online marketplace.

Alternatively, the notification fee could be computed using a fee schedule, such as: 5% of the amount below $100, 2.5% of the amount over $100

Alternatively, the notification fee for each user could remain equal to the bid amount during the fee period, instead of decreasing when other notification groups are processed.

Alternatively, the notification fee for each user could start at the bid amount and decrease linearly and continuously (without steps) towards zero during the fee period.

Alternatively, the notification fee for each user could start at the bid amount and decrease with regular steps during the fee period, with or without correlation with the sending of later notifications.

Alternative methods of notification besides those mentioned in the description could be used.

When an item matches multiple notification requests from the same user, we have described in a preferred embodiment how we kept only the notification request with the highest bid value, but alternative choices are possible including: honoring all notification requests with their stated bids; or keeping only the notification request with the lowest bid value

Normally, the online marketplace user will specify the method to be used for notifying him in his user registration, and the notification requests will contain only a user identifier (allowing to access the user table). However, the methods for notification, such as email address or instant messenger id, could be also specified in the notification requests themselves.

A user could be allowed to specify multiple notification methods, including some methods such as telephone or pager where he could incur a charge when they are used. A user could also be allowed to specify a sequence or protocol for being notified using these multiple notification methods.

In some embodiments, the time schedule for delivering the notifications may depend on how well the item matches the notification requests.

In the description of a preferred embodiment, we have chosen to privilege simplicity and ease of understanding of the method. There are many performance enhancements which might be advantageous to consider when applying this method to a high-volume online marketplace. Examples of such enhancements could be: memory caching; duplicating some fields in various tables, grouping and minimizing database accesses; using priority queues for storing pending notifications.

Notification requests can be set to expire after a predetermined amount of time, for example a month, unless renewed.

Accordingly, the scope of the invention should be determined not by the embodiment(s) illustrated, but by the appended claims and their legal equivalents.

In the claims which follow, reference characters used to denote process steps are provided for convenience of description only, and not to imply a particular order for performing the steps or that the steps are not overlapping.

FIG. 8 is a time diagram showing how the notification fees paid by various users evolve as the notification process proceeds, in a preferred embodiment. Fees displayed are for an item with an immediate purchase price of $100, if the item matches the notification requests of Greg, Mark and Jane which have offered respectively 30%, 5% and 3% bids in order to be notified.

FIG. 9 is a time diagram showing how the notification fees paid by various users evolve as the notification process proceeds, in a variation of a preferred embodiment where the immediate purchase option is deactivated immediately after the blackout period. Fees displayed are for an item with an immediate purchase price of $100, if the item matches the notification requests of Greg, Mark and Jane which have offered respectively 30%, 5% and 3% bids in order to be notified.

I claim:

1. A method, performed in the context of an online marketplace where at least one item is offered for sale daily and can be purchased in exchange for a predetermined amount of currency, for sending a notification to a user participating to the online marketplace, the method comprising the steps of:
(a) receiving at least one notification request from the user;
(b) sending the notification to the user if the item matches the notification request;
(c) preventing a plurality of users, who have not been notified of the item's availability, from purchasing the item during a blackout period;
(d) billing the user a notification fee if the user purchases the item.

2. The method of claim 1, wherein said notification fee is a predetermined percentage of the predetermined amount of currency.

3. The method of claim 1, wherein said notification fee is a percentage of the predetermined amount of currency, and wherein said percentage decreases as the amount of time elapsed between the time when the item was offered for sale and the time of purchase increases.

4. The method of claim 3, further comprising deactivating the immediate purchase option at the end of the blackout period.

5. The method of claim 3, further comprising providing an incentive for a plurality of sellers to use an immediate purchase option.

6. The method of claim 1, wherein said notification fee is billed only if the purchase occurred during a fee period.

7. The method of claim 6, further comprising providing an incentive for a plurality of sellers to use an immediate purchase option.

8. The method of claim 6, wherein said notification fee is a predetermined percentage of the predetermined amount of currency.

9. The method of claim 6, wherein said notification fee is a percentage of the predetermined amount of currency, and wherein said percentage decreases as the amount of time elapsed between the time when the item was offered for sale and the time of purchase increases.

10. The method of claim 9, further comprising providing an incentive for a plurality of sellers to use an immediate purchase option.

11. A method, performed in the context of an online marketplace where at least one item is offered for sale daily and can be purchased in exchange for a predetermined amount of currency, for sending a notification to a user participating to the online marketplace, the method comprising the steps of:
(a) receiving at least one notification request from the user;
(b) sending the notification to the user if the item matches the notification request;
(c) billing the user a notification fee if the user purchases the item during a fee period.

12. The method of claim 11, wherein said notification fee is a predetermined percentage of the predetermined amount of currency.

13. The method of claim 12, further comprising deactivating the immediate purchase option at the end of the fee period.

14. The method of claim 11, wherein said notification fee is a percentage of the predetermined amount of currency, and wherein said percentage decreases as the amount of time elapsed between the time when the item was offered for sale and the time of purchase increases.

15. The method of claim 14, further comprising deactivating the immediate purchase option at the end of the fee period.

16. The method of claim 14, further comprising providing an incentive for a plurality of sellers to use an immediate purchase option.

17. A method, performed in the context of an online marketplace where at least one item is offered for sale daily and can be purchased in exchange for a predetermined amount of currency, for sending a notification to a user participating to the online marketplace, the method comprising the steps of:
(a) receiving at least one notification request from the user, said notification request comprising a query and a bid;
(b) sending a notification to the user if the item matches said query, wherein the notification is sent at a time determined at least in part by the amount of said bid;
(c) preventing a plurality of users, who have not been notified of the item's availability, from purchasing the item during a blackout period;
(d) billing the user a notification fee if the user purchases the item.

18. The method of claim 17, wherein said notification fee is determined at least in part by the amount of said bid.

19. The method of claim 18, further comprising providing an incentive for a plurality of sellers to use an immediate purchase option.

20. The method of claim 18, further comprising deactivating the immediate purchase option at the end of the blackout period.

21. The method of claim 17, wherein said bid is specified as a percentage, and said notification fee is equal to said percentage of the purchase price.

22. The method of claim 18, wherein said notification fee is determined at least in part by the amount of time elapsed between the time when the item was offered for sale and the time of purchase.

23. The method of claim 17, wherein said notification fee is billed only if the purchase occurred during a fee period.

24. The method of claim 23, wherein said notification fee is determined at least in part by the amount of said bid.

25. The method of claim 24, further comprising deactivating the immediate purchase option at the end of the blackout period.

26. The method of claim 24, further comprising providing an incentive for a plurality of sellers to use an immediate purchase option.

27. The method of claim 24, wherein said notification fee is determined at least in part by the amount of time elapsed between the time when the item was offered for sale and the time of purchase.

28. The method of claim 27, further comprising providing an incentive for a plurality of sellers to use an immediate purchase option.

29. The method of claim 27, further deactivating the immediate purchase option at the end of the blackout period.

30. A method, performed in the context of an online marketplace where at least one item is offered for sale daily and can be purchased in exchange for a predetermined amount of currency, for sending a notification to a user participating to the online marketplace, the method comprising the steps of:
(a) receiving at least one notification request from the user, said notification request comprising a query and a bid;
(b) sending a notification to the user if the item matches said query, wherein the notification is sent at a time determined at least in part by the amount of said bid;
(c) billing the user a notification fee if the user purchases the item during a fee period.

31. The method of claim 30, wherein said notification fee is determined at least in part by the amount of said bid.

32. The method of claim 30, wherein said notification fee is determined at least in part by the amount of time elapsed between the time when the item was offered for sale and the time of purchase.

33. The method of claim 31, wherein said notification fee is determined at least in part by the amount of time elapsed between the time when the item was offered for sale and the time of purchase.

34. The method of claim 31, further comprising providing an incentive for a plurality of sellers to use an immediate purchase option.

35. The method of claim 33, further comprising providing an incentive for a plurality of sellers to use an immediate purchase option.

36. A method, performed on a multi-user computer system running an online marketplace, for providing notifications of the availability of an item, the method comprising the steps of:
(a) receiving at least one notification request from each of a plurality of users of the online marketplace, said notification request comprising:
(1) a query, used for matching items of interest;
(2) a bid, used for prioritizing notifications and determining a notification fee; (3) an identifier, used for uniquely identifying the user submitting the notification request;
(b) performing, each time a new item is offered for sale and can be purchased in exchange for a predetermined amount of currency, the method comprising the steps:
(i) determining, for said new item, a set of eligible users, consisting of the users who have submitted at least one notification request where said new item matches the query specified in said at least one notification request;
(ii) determining a time schedule for the delivery of notifications to the eligible users, wherein said time schedule depends on the values of the bids specified in at least one of the notification requests submitted by the eligible users;
(iii) sending a notification to at least one of the eligible users, according to said time schedule, stating that said new item is available for sale;
(iv) billing a notification fee if one of the eligible users purchases said new item, wherein the amount of said notification fee depends on factors comprising: (a) the time at which the purchase occurred; (b) the value of the bid specified in at least one of the notification requests submitted by the eligible users;
(v) preventing the users who have not been notified of said new item's availability from purchasing said new item during a predetermined blackout period.

37. The method of claim 36, further comprising providing an incentive for a plurality of sellers to use an immediate purchase option.

38. The method of claim 36, further comprising deactivating an immediate purchase option at the end of the blackout period.
